(19) United States
(12) Patent Application Publication
(10) Pub. No.: US 2006/0170842 A1
(43) Pub. Date: Aug. 3, 2006

(54) Planar light source device and liquid crystal display apparatus

(75) Inventors: Makoto Shimizu, Kanazawa-shi (JP); Toshihiko Ura, Nomi-shi (JP); Yoshinori Yasuda, Ishikawa-gun (JP); Hiromi Kaneda, Hakusan-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/336,854

(22) Filed: Jan. 23, 2006

(30) Foreign Application Priority Data
Jan. 31, 2005 (JP) 2005-023792

(51) Int. Cl. G02F 1/1335

(52) U.S. Cl. 349/65

(57) ABSTRACT

A liquid crystal display apparatus includes a liquid crystal display panel including a display region in which a plurality of pixels are arrayed, and a planar light source device which illuminates the liquid crystal display panel from behind it. The planar light source includes cold cathode fluorescent tubes, a back surface cover, which is substantially rectangular and stores the cold cathode fluorescent tubes, and an upper surface cover attached to the back surface cover. The back surface cover has at least two extended portions, each having a main body portion extending from a side of the back surface cover and a lug portion protruding from the main body portion. The upper surface cover has supporting portions, each supporting at least the lug portion of each extended portion.

### CROSS-REFERENCE TO RELATED APPLICATIONS

This application is based upon and claims the benefit of priority from prior Japanese Patent Application No. 2005-023792, filed Jan. 31, 2005, the entire contents of which are incorporated herein by reference.

### BACKGROUND OF THE INVENTION

1. Field of the Invention

The present invention relates to a planar light source device and a liquid crystal display apparatus. In particular, the present invention relates to a planar light source device of an area light system, which does not comprises a light guide and but has a light source facing an object to be illuminated, and to a liquid crystal display apparatus comprising the planar light source device.

2. Description of the Related Art

In recent years, a liquid crystal display apparatus, which displays images on a liquid crystal display panel, has been widely used as a display of a personal computer or the like. Lately, as liquid crystal screen TV sets have come into wide use, the display screen is required to be wider and brighter.

Generally, a liquid crystal display apparatus comprises a liquid crystal display panel which displays images and a planar light source device, which illuminates the liquid crystal display panel from behind it. The planar light source device has, for example, a cold cathode fluorescent tube as a light source, a back surface cover which stores the cold cathode fluorescent tube, and an upper surface cover attached to the back surface cover.

A planar light source device of a so-called area light system does not have a light guide and has a plurality of light sources arranged just under the object to be illuminated (liquid crystal display panel). The planar light source device of the area light type is particularly utilized widely as a planar light source device of a large liquid crystal display apparatus, because it can be brighter and more lightweight than the planar light source device of the edge light system having a light guide. However, it is difficult to ensure sufficient stiffness of the planar light source device of the area light system, because of its structure.

Jpn. Pat. Appln. KOKAI Publication No. 2002-90736 discloses a structure as described below, in order to increase the stiffness of the planar light source device. The back surface cover comprises a substantially rectangular flat plate, and longer sides of the plate are bent upward. The upper surface cover is shaped as a substantially rectangular frame that has a window portion serving as a light exit region. The light emitted from the cold cathode fluorescent tube passes through the light exit region. The upper surface cover further has an extending portion extending from the edge of the window portion toward the cold cathode fluorescent tube. The upper surface cover is attached to the back surface cover such that the extending portion supports the longer sides of the back surface cover.

However, if the upper surface cover is attached to the back surface cover as described above, the shorter sides of the back surface cover cannot be fixed. Therefore, sufficient stiffness against external force applied to the planar light source device may not be obtained. Further, in a large liquid crystal display apparatus, if the planar light source device as described above is combined with a liquid crystal display panel, distortion of the planar light source device or slight external force may apply stress to the liquid crystal display panel. In this case, the liquid crystal display apparatus may display defective images.

### BRIEF SUMMARY OF THE INVENTION

The present invention has been made in consideration of the above problems of the prior art, and an object of the present invention is to provide a planar light source device which has sufficient stiffness against external force and a liquid crystal display apparatus having the planar light source device.

According to a first aspect of the present invention, there is provided a planar light source device comprising: a light source; a back surface cover, which is substantially rectangular and stores the light source; and an upper surface cover attached to the back surface cover, wherein: the back surface cover has at least two extended portions, each having a main body portion extending from a side of the back surface cover and a lug portion protruding from the main body portion; and the upper surface cover has supporting portions, each supporting at least the lug portion of each extended portion.

According to a second aspect of the present invention, there is provided a liquid crystal display apparatus comprising: a liquid crystal display panel including a display region in which a plurality of pixels are arrayed; and a planar light source device which illuminates the liquid crystal display panel, the planar light source comprising: a light source; a back surface cover, which is substantially rectangular and stores the light source; and an upper surface cover attached to the back surface cover, wherein the back surface cover has at least two extended portions, each having a main body portion extending from a side of the back surface cover and a lug portion protruding from the main body portion; and the upper surface cover has supporting portions, each supporting at least the lug portion of each extended portion.

According to the present invention, it is possible to provide a planar light source device which has sufficient stiffness against external force, and a liquid crystal display apparatus including the planar light source device. Further, according to the present invention, it is possible to provide a liquid crystal display apparatus having satisfactory display quality, in which stress applied to the liquid crystal display panel from the planar light source device is reduced, when the planar light source device is coupled with the liquid crystal display panel.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view of a liquid crystal display apparatus according to an embodiment of the present invention;

FIG. 2 is an exploded perspective view of the planar light source device of the liquid crystal display apparatus shown in FIG. 1;

FIG. 3 is a view of a corner portion of a back surface cover of the planar light source device shown in FIG. 2, as viewed from the back side of the back surface cover;

FIG. 4 is a view of a corner portion of an upper surface cover of the planar light source device shown in FIG. 2, as viewed from the back side of the upper surface cover; and

FIG. 5 is a view of a corner portion of the planar light source device shown in FIG. 2, as viewed from the back side of the planar light source device.

### DETAILED DESCRIPTION OF THE INVENTION

A liquid crystal display apparatus according to an embodiment of the present invention will be described with reference to the accompanying drawings.

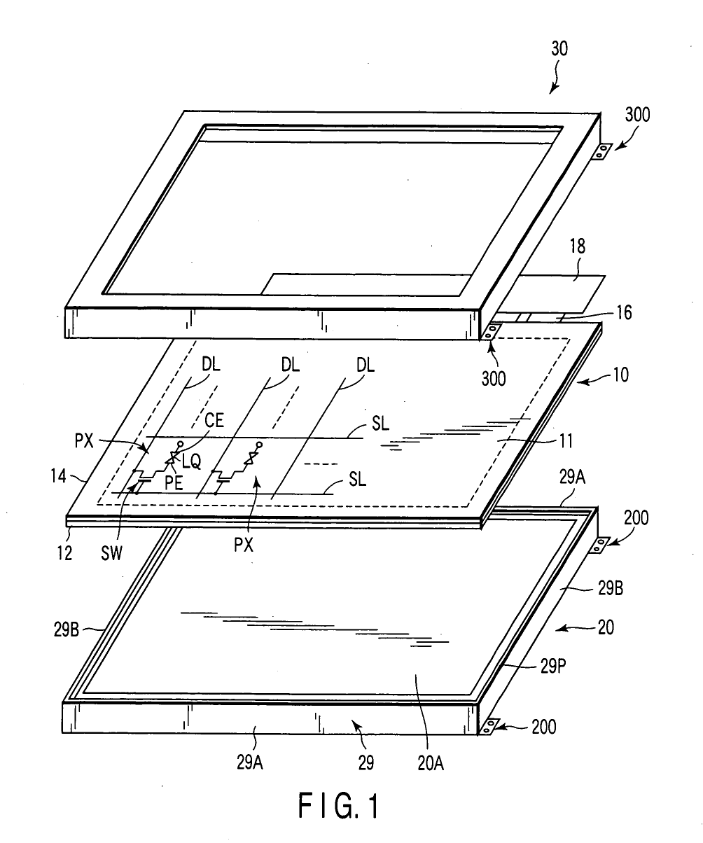

As shown in FIG. 1, the liquid crystal display apparatus comprises a liquid crystal display panel 10, a planar light source device 20 which illuminates the liquid crystal display panel 10 from behind it (from the side of an array substrate 12 described later), and a frame 30, which is attached to the liquid crystal display panel 10 from above it. The planar light source device 20 and the frame 30 respectively have attachment portions 200 and 300 to be attached to an external unit (for example, a housing of a television unit).

The liquid crystal display panel 10 comprises a pair of substrates which are arranged opposite to each other; that is, an array substrate 12 and a counter substrate 14. It also comprises a liquid crystal layer LQ, which is sandwiched between the array substrate 12 and the counter substrate 14. A polarizing plate (not shown) is attached to the outer side of each of the array substrate 12 and the counter substrate 14.

The liquid crystal display panel 10 has a substantially rectangular display region 11 for displaying images. The display region 11 comprises a plurality of display pixels PX arranged in a matrix. The array substrate 12 has, in the display region 11, a plurality of scanning lines SL extending in a row direction of the pixels PX, a plurality of signal lines DL extending in a column direction of the pixels PX, a plurality of switching elements SW provided in the respective pixels PX, and pixel electrodes PE connected to the switching elements SW. In each pixel, the switching element SW is arranged near the intersection between the scanning line SL and the signal line DL. The counter substrate 14 comprises a counter electrode CE common to all the pixel electrodes PX in the display region 11.

The array substrate 12 and the counter substrate 14 are arranged such that the pixel electrodes PE face the counter electrode CE with a gap therebetween. The liquid crystal layer LQ is formed of a liquid crystal composition sealed in the gap between the array substrate 12 and the counter substrate 14.

The circuit board 18 is electrically connected to a side end of the liquid crystal display panel 10 by a flexible board 16, and supplies a drive signal to the liquid crystal display panel 10. The circuit board 18 is arranged on the back surface of the planar light source device 20 (the opposite side from the illumination light exit surface described later) by bending the flexible board 16 toward the back surface of the planar light source device 20.

The planar light source device 20 comprises a substantially rectangular light exit region 20A from which illumination light exits. The planar light source device 20 is stacked on the back surface of the liquid crystal display panel 10 such that the light exit region 20A faces the display region 11 of the liquid crystal display panel 10.

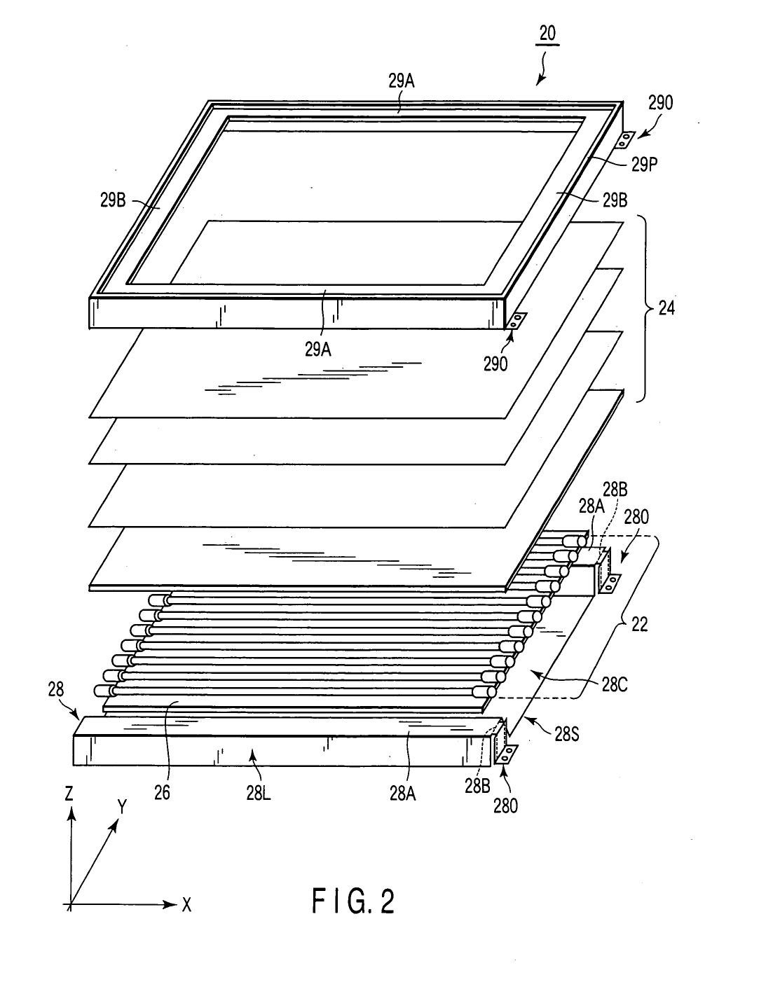

As shown in FIG. 2, the planar light source device 20 has a plurality of cold cathode fluorescent tubes 22 serving as a light source, a back surface cover 28 which stores the cold cathode fluorescent tubes 22, and an upper surface cover 29 attached to the back surface cover 28 from above it. The planar light source device 20 also has a plurality of optical sheets 24 and an optical sheet 26.

The cold cathode fluorescent tubes 22 are of, for example, straight tube type. They are arranged such that the axes thereof are substantially parallel to each other. The optical sheets 24 are arranged above the cold cathode fluorescent tubes 22 (on the side facing the liquid crystal display panel 10). The optical sheets 24 are a diffusion plate or diffusion sheet which diffuses the light emitted from the cold cathode fluorescent tubes 22, a prism sheet which focuses the diffused light, a polarized light separating sheet, etc. The optical sheet 26 is arranged on the back surface side of the cold cathode fluorescent tubes 22. The optical sheet 26 is a reflection sheet which reflects the light emitted from the cold cathode fluorescent tubes 22 on the back surface side to the main surface side.

The back surface cover 28 is made of, for example, metal and has a substantially rectangular shape. It stores the cold cathode fluorescent tubes 22, the optical sheets 24 and the optical sheet 26. The upper surface cover 29 is attached to the back surface cover 28 over the optical sheets 24. In other words, the optical sheets 24, the cold cathode fluorescent tubes 22 and the optical sheet 26 are retained between the back surface cover 28 and the upper surface cover 29.

Details of the structure of the planar light source device 20 will be described below with reference to FIGS. 2 to 5. In these figures, the longitudinal direction of the planar light source device 20 is indicated as an X direction, the direction perpendicular to the X direction is indicated as a Y direction, the thickness direction of the planar light source device 20 is indicated as a Z direction, and the plane defined by the X and Y directions is called a principal plane of the planar light source device 20.

Longer side portions 28L of the back surface cover 28 extend in the X direction and bend up toward the upper surface cover. Each of the longer side portions 28L has a substantially U-shaped cross section in the plane perpendicular to the X direction. The bottom surface 28A of the U-shaped cross section extends in the X direction, and has a substantially flat shape, which is substantially parallel to the principal plane of the planar light source device 20. The back surface cover 28 has a recess portion 28C to store the optical sheet 26 and the cold cathode fluorescent tubes 22 between the longer side portions 28L.

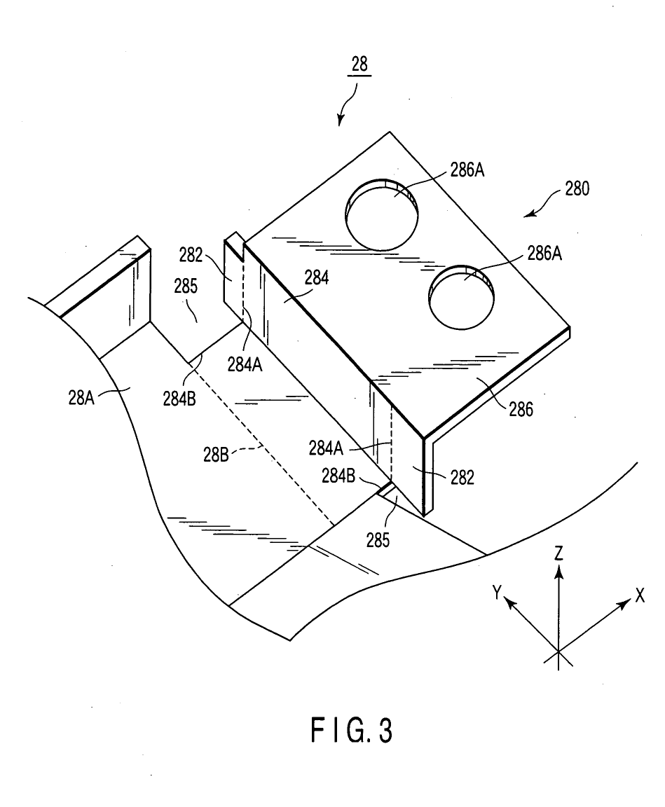

The back surface cover 28 having the above configuration has at least two extended portions 280 extended from one side. FIG. 3 shows a corner portion of the extended portion as viewed from the back side of the back surface cover 28. As shown in FIG. 3, the extended portion 280 has a main body portion 284 extending from the back surface cover 28 and a lug portion 282 protruding from the main body portion 284. In this embodiment, the extended portion 280 is formed on each of the shorter sides 28S of the back surface cover 28. The two extended portions 280 are formed near the ends of the shorter side 28S, in this embodiment, extend from ends 28B of the bottom surface 28A.

The main body portion 284 extends outward from the ends 28B of the bottom surface 28A of the back surface cover 28 in the direction along the longer sides of the back surface cover (the X direction), then it is bent substantially at right angles and extends in the thickness direction of the planar light source device 20 (the Z direction) toward the back side of the back surface cover 28. The lug portion 282 protrudes from an edge 284A extending in the Z direction of the main body portion 284, and extends along the shorter side 28S of the back surface cover 28 (the Y direction). The lug portion 282 has a planar shape extending in the thickness direction of the planar light source device 20 (the Z direction). In this embodiment, the lug portions 282 are formed on both ends of the main body portion 284.

Cut portions 285 are formed on both ends of the main body portion 284. The cut portion 285 is defined by the lug portion 282, the shorter side of the back surface cover 28 and an edge portion 284B of the main body portion 284 extending in the X direction.

Further, the extended portion 280 has an attachment portion 286 to attach the planar light source device 20 or the liquid crystal display apparatus to an external unit. This attachment portion 286 extends outward from the top end of the main body portion 284 to the outside of the planar light source device 20, that is, in the X direction. The attachment portion 286 has through holes 286A, which are used to screw the planar light source device 20 to an external device.

The upper surface cover 29 will now be described. As shown in FIG. 2, the upper surface cover 29 is formed of resin and shaped into a substantially rectangular frame. The upper surface cover 29 has frame portions 29A extending in the X direction along the longer sides, and frame portions 29B extending in the Y direction along the shorter sides. The frame portions 29A hold the longer side portions 28L of the back surface cover 28. The frame portions 29B correspond to the shorter sides 28S of the back surface cover 28.

The upper surface cover 29 having the structure as described above has supporting portions 290, which hold at least the lug portions 282 of the extended portions 280. The supporting portions 290 are formed in positions corresponding to the extended portions 280 of the back surface cover 28, i.e., near corner portions of the frame portion 29B on the shorter sides.

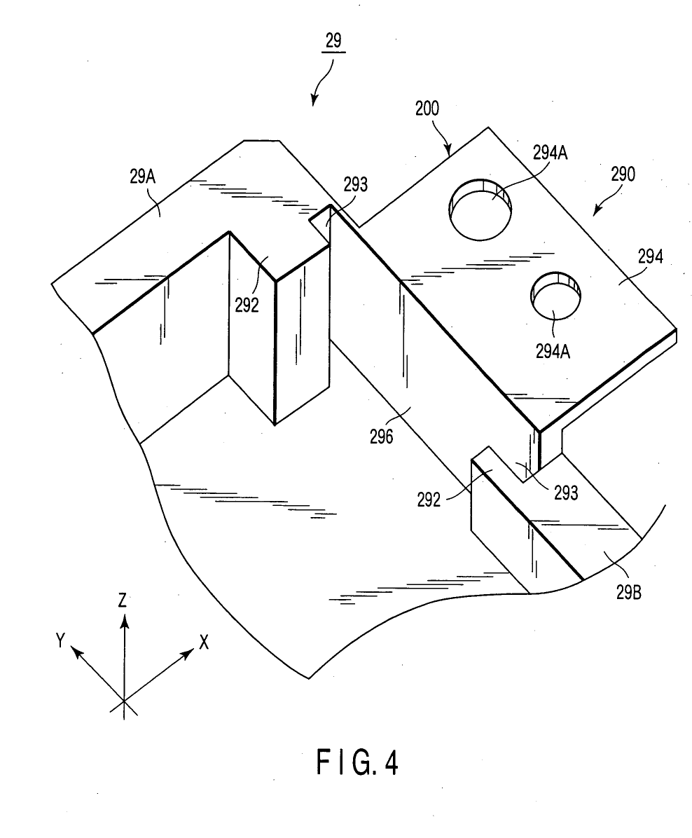

FIG. 4 is a view of a corner portion of the upper surface cover 29, as viewed from the back side of the upper surface cover 29. As shown in FIG. 4, the supporting portion 290 has a side wall portion 296, which forms a part of the frame portion 29B on a shorter side, and two grasping portions 292 extending in the Y direction from the inner sides of the frame portions 29A and 29B of a longer side and a shorter side.

The two grasping portions 292 face the side wall portion 296 with a predetermined gap therebetween. Therefore, a recess portion 293 is formed between the side wall portion 296 and each of the grasping portion 292. The length of the recess portion 293 in the X direction is substantially equal to the thickness (the length in the X direction) of the lug portion 282 of the extended portion 280.

Further, the supporting portion 290 also has an attachment portion 294 to attach the planar light source device 20 or the liquid crystal display apparatus to an external unit. This attachment portion 286 extends outward from an edge of the side wall portion 296 to the outside of the planar light source device 20, that is, in the X direction. The attachment portion 294 has through holes 294A, which are used to screw the planar light source device 20 to an external device.

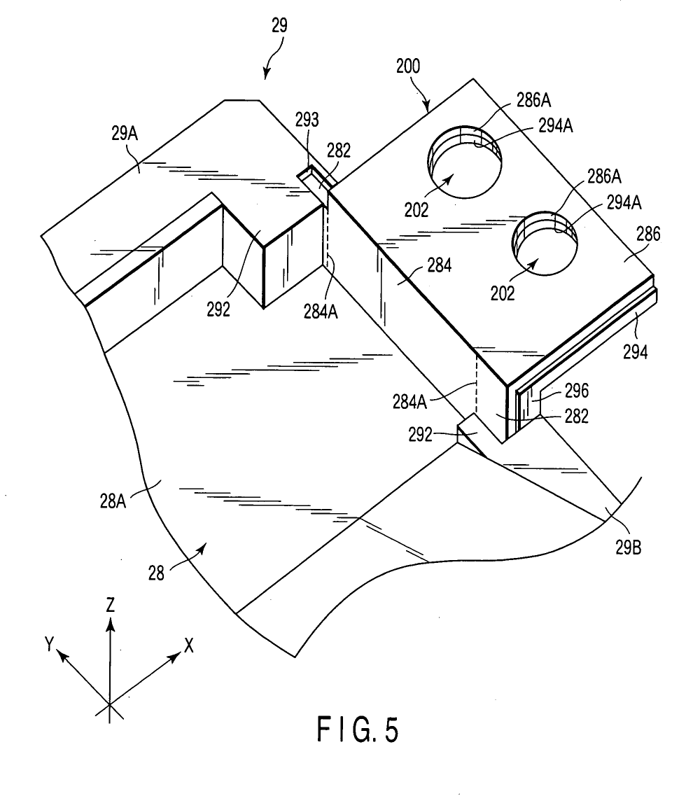

FIG. 5 is a view of a corner portion of the planar light source device 20, as viewed from the back side of thereof. When the back surface cover 28 and the upper surface cover 29 are attached to each other, as shown in FIG. 5, the supporting portion 290 supports the extended portion 280. At this time, the grasping portion 292 of the supporting portion 290 engages with the cut portion 285 of the extended portion 280, and the lug portion 282 of the extended portion engages with the recess portion 293 of the supporting portion 290. Thus, the lug portion 282 of the extended portion 280 is grasped between the grasping portion 292 and the side wall portion 296 of the supporting portion 290, with the result that the extended portion 280 is fixed to the supporting portion 290.

The main body portion 284 and the attachment portion 286 of the extended portion 280 are overlaid on and attached to the side wall portion 296 and the attachment portion 294 of the supporting portion 290. The attachment portion 286 of the extended portion 280 and the attachment portion 294 of the supporting portion 290 are overlaid on each other along the Z direction, thereby forming the attachment portion 200 of the planar light source device 20. The attachment portion 200 of the planar light source device 20 has through holes 202, which extend in the Z direction through both the attachment portion 286 of the extended portion 280 and the attachment portion 294 of the supporting portion 290. In other words, the through holes 286A of the attachment portion 286 and the through holes 294A of the attachment portion 294 are respectively located substantially coaxially with each other, thus forming the through holes 202.

Since the extended portion 280 of the back surface cover 28 engages with the supporting portion 290 of the upper surface cover 29 as described above, the shorter sides 28S, as well as the longer side portions 28L, are supported by the upper surface cover 29. As a result, the back surface cover 28 is fixed to the upper surface cover 29 at its four sides, so that the stiffness of the planar light source device 20 can be increased. In particular, since the back surface cover 28 is fixed to the upper surface cover 29 at two or more parts on the shorter side, the stiffness against external force in a distorted direction can be increased.

Further, if external force in a distorted direction is applied to the back surface cover 28, the displacement is the greatest at a corner portion (an end portion of a side). Therefore, the deformation by torsion of the planar light source device is effectively suppressed by fixing the back surface cover 28 to the upper surface cover at portions near the corners of the shorter sides. Consequently, with the liquid crystal display apparatus having the above planar light source device, stress applied to the liquid crystal display panel from the planar light source device is reduced, thereby preventing defective image display.

Furthermore, since the stiffness of the planar light source device 20 is increased by fixing the back surface cover 28 to the upper surface cover 29, the back surface cover 28 can be thinner than a conventional one. For example, a conventional back surface cover is made of metal material having a thickness of 2 mm. However, according to the above embodiment, even when the back surface cover 28 made of metal material having a thickness of 1 mm was used, sufficient stiffness was ensured. Thus, the planar light source 20 can be lightweight and cost-saving.

Moreover, the extended portion 280 and the supporting portion 290 have attachment portions 286 and 294 to attach the planar light source device or the liquid crystal display apparatus to an external unit. When the upper surface cover 29 is attached to the back surface cover 28, the main body portion 284 and the attachment portion 286 of the extended portion 280 made of metal are respectively overlaid on and fixed to the side wall portion 296 and the attachment portion 294 of the supporting portion 290.

As a result of the above structure, the attachment portion 200 of the planar light source device 20 is also reinforced. In addition, the extended portion 280 is supported by the supporting portion 290 so as to restrict the displacement along the direction in which the attachment portion 200 extends. Therefore, even if external force is applied in the direction in which the attachment portion 200 extends, the attachment portion 200 is prevented from being damaged or distorted. As a result, the manufacturing yield can be improved. Furthermore, the planar light source device can be sufficiently large as required according to the upsizing of the liquid crystal display apparatus.

The upper cover 29 has a positioning portion 29P to position the liquid crystal panel 10 when the planar light source device 20 as described above is coupled with the liquid crystal display panel 10. The liquid crystal display panel 10, positioned with respect to the positioning portion 29, is sandwiched between the planar light source device 20 and the frame 30. Therefore, the light exit region 20A of the planar light source device 20 and the display region 11 of the liquid crystal display panel 10 can easily face each other. Thus, the manufacturing yield is improved.

When the planar light source device 20 and the frame 30 are coupled, the attachment portions 200 and 300 are overlaid on each other. More specifically, the attachment portion 294 of the upper surface cover 29 is held between the attachment portion 286 of the back surface cover 28 and the attachment portion 300 of the frame 30. For this reason, it is ensured that even a large-sized liquid crystal display apparatus has sufficient strength to support its own weight with the attachment portion.

The present invention is not limited to the above-mentioned embodiments and the elements can be variously modified when practiced without departing from the scope of the invention. Further, some of the plurality of elements of the embodiment described above may be suitably combined, so that various inventions may be achieved. For example, some of the elements may be deleted from all elements of the embodiment. Furthermore, some elements of different embodiments may be suitably combined.

For example, in the above embodiment, the extended portions 280 and the supporting portions 290 are the elements necessary to increase the stiffness of the planar light source device. Therefore, they do not necessarily have the attachment portions 286 and 294.

Further extended portions 280 and the supporting portions 290 may be formed in positions in addition to both ends of the shorter side of the planar light source device 20. In this case, the stiffness of the planar light source device can further increase.

What is claimed is:

1. A planar light source device comprising:
a light source;
a back surface cover, which is substantially rectangular and stores the light source; and
an upper surface cover attached to the back surface cover, wherein:
the back surface cover has at least two extended portions, each having a main body portion extending from a side of the back surface cover and a lug portion protruding from the main body portion; and
the upper surface cover has supporting portions, each supporting at least the lug portion of each extended portion.

2. The planar light source device according to claim 1, wherein:
the main body portion extends in a thickness direction of the planar light source device; and
the lug portion has a planar shape extending in the thickness direction of the planar light source device.

3. The planar light source device according to claim 1, wherein the extended portions are formed on a shorter side of the back surface cover.

4. The planar light source device according to claim 1, wherein the lug portion protrudes from the main body portion along the side of the back surface cover where the extended portions are formed.

5. The planar light source device according to claim 1, wherein each of the extended portions and the supporting portions has an attachment portion to attach the planar light source device to an external unit.

6. The planar light source device according to claim 5, wherein the attachment portion of the extended portion extends from a top end of the main body portion to outside of the planar light source device.

7. The planar light source device according to claim 5, wherein the attachment portion of the supporting portion is overlaid on the attachment portion of the extended portion.

8. The planar light source device according to claim 1, wherein the at least two extended portions are respectively formed in proximity to two end portions of the side.

9. A liquid crystal display apparatus comprising:
a liquid crystal display panel including a display region in which a plurality of pixels are arrayed; and
a planar light source device which illuminates the liquid crystal display panel,
the planar light source comprising:
a light source;
a back surface cover, which is substantially rectangular and stores the light source; and
an upper surface cover attached to the back surface cover, wherein
the back surface cover has at least two extended portions, each having a main body portion extending from a side of the back surface cover and a lug portion protruding from the main body portion; and
the upper surface cover has supporting portions, each supporting at least the lug portion of each extended portion.

10. The liquid crystal display apparatus according to claim 9, wherein the upper surface cover has a positioning portion to position the liquid crystal display panel.
